(19) United States
(12) Patent Application Publication
(10) Pub. No.: US 2016/0107172 A1
(43) Pub. Date: Apr. 21, 2016

(54) PROTECTION TILES FOR SCROLL CONVEYOR FLIGHTS

(71) Applicant: ANDRITZ S.A.S., Vélizy-Villacoublay (FR)

(72) Inventors: Denis LAMY, Chateauroux (FR); Jean-Marc HUYGHE, Le Poinconnet (FR)

(21) Appl. No.: 14/890,352

(22) PCT Filed: May 15, 2013
(86) PCT No.: PCT/EP2013/001436

§ 371 Date: Nov. 10, 2015

(51) Int. Cl. B04B 9/12; B04B 1/04

(52) U.S. Cl. CPC B04B 9/12; B04B 1/04

(57) ABSTRACT

The invention is related to a scroll conveyor tile protection or any other material subject to wear with a weldable support (41) and a wear resistant insert (6), not necessary weldable. The support (41) is fit with a flat surface and shoulder allowing for precise positioning of tile on a scroll flight (3) to be protected. At least one opening, preferably at its center, allows for insertion and assembly of a complementary shaped insert. The unit setting up on the scroll flight and the contact between the flight faces and the unit faces allows for creating a dove tail locking system. Welding of the support permanently insures locking of the system and insert being maintained without other means of fixation than this mechanical clamping.

The present invention concerns a protection tile for scroll flight wear protection.

For this type of centrifuge scroll, there is generally a tile protection avoiding flight wear and allowing for durable conveyance when the product to be transported is particularly abrasive.

These protection elements are usually fabricated using carbon tungsten or ceramics, with a coefficient of thermal expansion which can defer significantly from steel which is generally the element of the flight. Assembly of these elements is particularly delicate and several patents proposing solutions concerning rivets, glue or weld, have already been published.

One solution known from U.S. Pat. No. 4,328,925 shows the assembly via a support with grooved dove tail locking system in which an abrasive resistant element is inserted on one side and constitutes a complimentary form. The position is held via glue or deformation of tab or blocking via a plate screwed onto the support. This solution does not insure ortho-radial support of element resistant to abrasion, sufficient enough for friction of product being displaced. These elements can slip and become dislodged.

The solution in EP 0 081 938 shows an assembly using an abrasive resistant element fixed on the scroll flight using conical rivets. This solution is difficult and costly to implement due to the necessity of drilling the flights.

U.S. Pat. No. 5,429,581 shows an assembly using an abrasive resistant element with male form lodging via an axial slippage into a complimentary housing located on the scroll flight. Even though this solution satisfactory allows for bearing radial, ortho-radial and axial loads, using this method is also difficult and costly to implement due to the requirements of machining for lodgment on the flights. Maintaining tiles in lodging is insured via glue or plates, cone and screws. Multiplication of these maintaining parts can be costly.

In U.S. Pat. No. 6,206,818 an assembly solution is shown using a support with dove tail locking system grooves in which abrasion resistant element is placed present in complimentary form. This element is inserted via side entry slippage or, if space between male and female forms permits, frontal entry. Fixation of the abrasive resistant element is achieved by glue injection into the existing gaps of the support. A hole in the rear of the support and grooves over two parts allow for glue spreading over all empty spaces. This gluing is possible after welding the support on a conveyor flight, which avoids possible alteration of glue due to high temperature welds. Precise positioning of supports before weld is needed to insure final continuity of the wear resistant elements. This requires using special tools as per patent U.S. Pat. No. 6,230,960 which can cause a long and costly assembling.

Considering the inconveniences of the prior art, the present invention defines a new protection tile capable of resisting different mechanical and tribological stresses which will be applied, with a simple, rapid tile assembly along the entire scroll flight.

Thus the invention is mainly characterized in that the support and wear-resistant insert are connected to each other by a mechanical locking system, whereby the support fixation on the flight insures the locking of the insert by purely mechanical clamping. These protection tiles are generally fixed on the flight of a centrifuge scroll or any other mechanical element allowing for product displacement with friction of said product. With such system no additional material as glue or braze is necessary to fix the insert to the support.

A further embodiment of the invention is characterized in that the support has at least one opening where the insert fits in, whereby preferably the insert has the same number of extensions to fit in each of the openings of the support.

An advantageous protection tile has shown that the support has at least one groove-like surface where the insert has a complementary form to fit in.

The invention further concerns a conveyor with a scroll, e.g. screw press, centrifuge, decanter and is characterized by a number of protection tiles mounted onto the scroll at its circumference where the support and wear-resistant insert are connected to each other by a mechanical locking system, whereby the support fixation on the flight insures the locking of the insert by purely mechanical clamping. Due to this purely mechanical clamping, the material used for tile insert can be any type and the invention eliminates any weld, braze, glue issues usually encountered between the support and the wear resistant insert. The use of a surface of the flight to complete a dovetail locking system is particularly advantageous as this simplifies at the same time the assembly and the locking of the tile and avoids a preliminary assembly of the support and the insert. Tile protection is then very quick to implement, with firstly an easy and simple insert fit into the support and secondly a usual support fixation on the flight of the scroll.

Invention defines a tile with a weldable support and a wear-resistant insert. The material used for tile support is generally stainless steel. All other types of steel, stainless or otherwise, may be used if weld adherent. To offer an efficient wear-resistant feature the insert may be made of special steel, tungsten carbide or other carbide or ceramic.

The invention is now described in accordance with the attached drawings, where

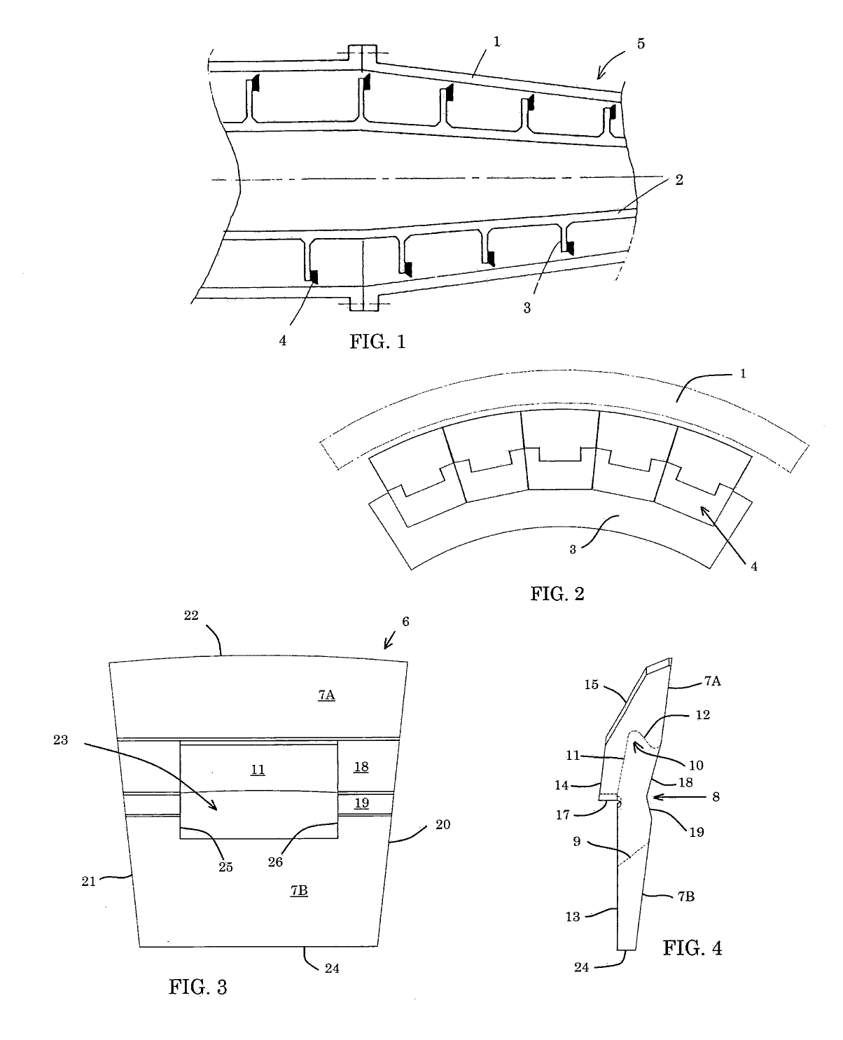

FIG. 1 is a layout of tiles on a scroll conveyor flight according to the invention,

FIG. 2 is a front view of scroll flight with 5 protection tiles according to the invention applied,

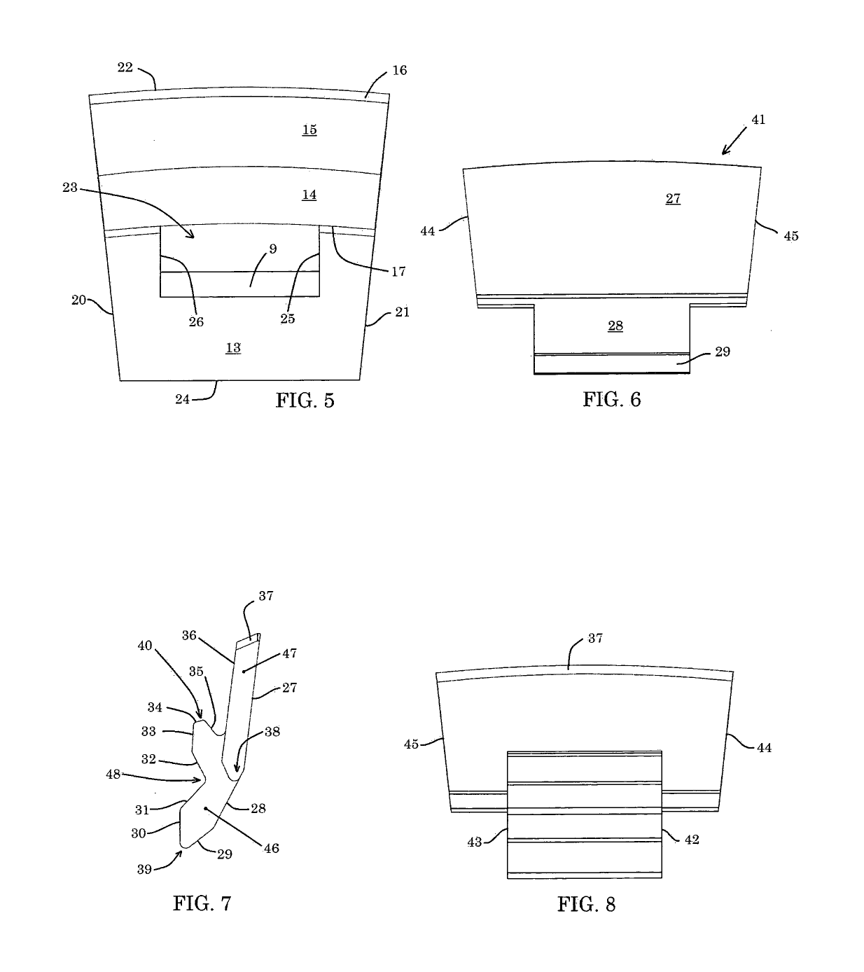

FIGS. 3-5 are front, left and rear views of the tile support according to one embodiment of the invention,

FIGS. 6-8 are front, left and rear views of the insert,

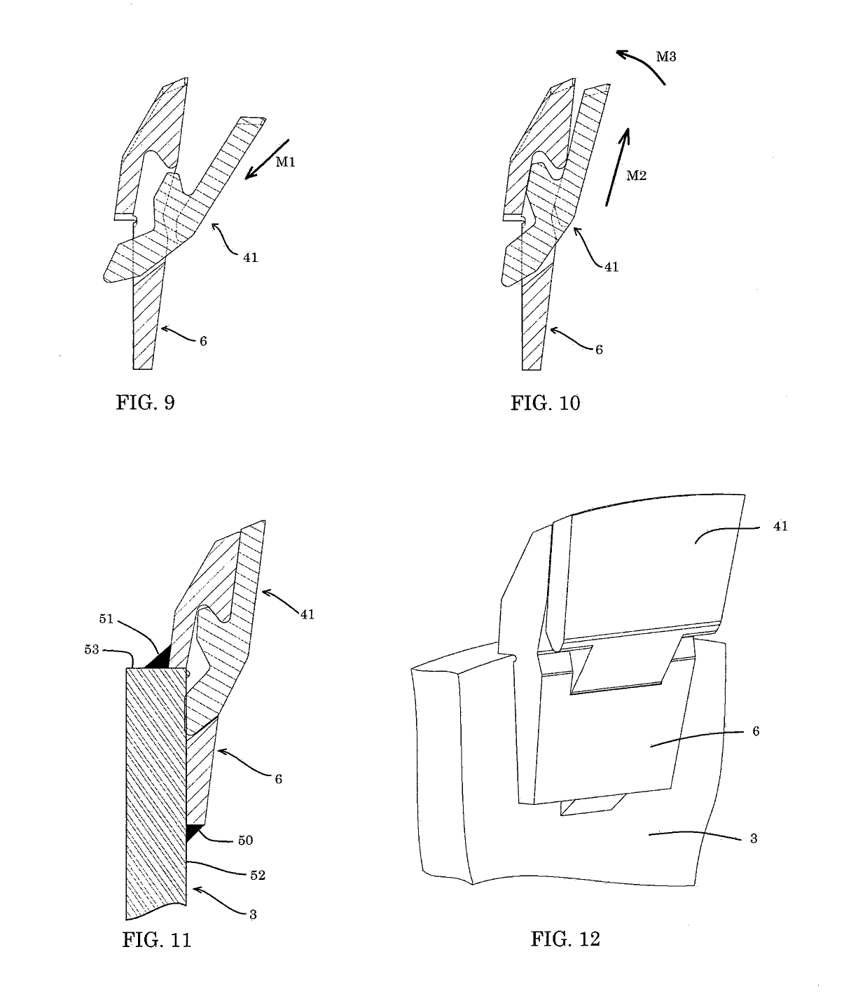

FIGS. 9-10 are section views of a protection tile according to the invention in intermediate assembly position for support and insert,

FIG. 11 is a section view for a protection tile according to the invention assembled and welded on a scroll conveyor flight,

FIG. 12 is a perspective view of a protection tile according to the invention assembled and welded on a scroll conveyor flight.

A centrifuge using the invention is illustrated in FIG. 1. The centrifuge 5 is composed of a cylindrical/conical bowl 1 and a conveyor scroll 2 in rotation around the same axis. The bowl 1 and the conveyor scroll 2 are driven in rotation at slightly different speeds generating a relative speed between bowl and scroll called a conveying speed. The scroll is generally comprised of a drum 2 and a flight 3 extending radially between drum 2 and bowl 1. Protection tiles 4 are deposited side by side on the exterior flight edge. The solid/liquid mixture to be separated is introduced to the bowl 1 by means of a feed tube, not shown. The product is driven at the speed of bowl 1 and, under centrifugal force the densest particles of the product are pressed against the interior wall of bowl 1. The scroll conveyor 2, due to its relative rotation movement transports the solid particles called sediment, towards the bowl cone head.

As illustrated in FIG. 2, protection tiles 4 fixed side by side on the flight 3 allow for protection of the flight 3 from generally abrasive friction from sediment and add to lifetime of scroll conveyor 2.

The support 6 according to the invention shown in FIGS. 3-5 has a front face 7A and 7B interrupted by a subsidence 8 defined by surfaces 18 and 19. The rear face of support 6 is comprised of two plane faces 13 and 14 offset and forming a shoulder 17. The lateral surfaces 20 and 21 are plane and form an angle which the tiles can set in, as illustrated in FIG. 2. An opening 23 limited by surfaces 9, 11, 12, 25 and 26 is achieved in this embodiment of the invention in the center of support 6. Surfaces 11 and 12 form a sharp angle and are connected via a radius comprising an upper corner 10. Support 6 is generally obtained by a process of precise molding with the object of obtaining exterior and interior forms to allow for assembly of the insert 41.

The insert 41 according to the invention shown in FIGS. 6-8 is comprised of a plate 47 and at least one finger 46 completely connected. Lateral surfaces 44 and 45 are plane and form an angle which the tiles can set in, as illustrated in FIG. 2. Plate 47 is limited by surfaces 27, 36, 37, 44, and 45 and comprises the active part of the protection tile since the friction of the product to be treated is mainly exerted onto the surface 27. The at least one finger 46 is limited by surfaces 28-35, 42 and 43 and insures the insertion of insert into support 6. The shape of the finger 46 is close to that of the dove tail locking system with upper and lower corners 40 and 39. Surfaces 31 and 32 form opening 48 needed for assembly. Insert 41 is generally obtained by a process of precise molding with the object of obtaining exterior and interior forms to allow for the assembly with the support 6.

The assembly of protection tile 4 onto the conveyor scroll 3 is achieved via the following steps. As shown in FIG. 9 and following arrow direction M1, insert 41 is introduced in support 6 by engaging lower corner 39 first in opening 23 of support 6 and by inclining insert 41 so as to form an angle with faces 27 and 7A. As shown in FIGS. 10 and 11, insert 41 is then progressively and simultaneously pivoted and moved following arrows direction M2 and M3 until complete engagement of the upper corner 40 of insert 41 into the complementary lodging 10 of the support 6 is achieved. Then this unit is positioned on flight 3 of scroll 2. Curve surface 17 and plane surface 13 of support 6 are respectively put in contact with exterior upper surface 53 and the front face 52 of scroll flight 3. The surface 52 then completes the dovetail locking system obtained by surfaces 29, 30, 33 and 35 of insert 41 and surfaces 9, 11 and 12 of support 6. The support is then fixed on the flight 3 generally by welding at angles 51 and 50 formed respectively by surfaces 14 and 53 and surfaces 24 and 52. This insures the assembly clamping and the insert 41 is being maintained without other means of fixation than this mechanical clamping. Dimensions of the two parts are such that the surface 30 of the insert 41 is generally off center towards the rear in relationship to surface 13. Surfaces 29 and 9 form a sharp angle with face 52 of flight 3; the pressure exerted by surface 52 on face 30 tends to push insert 41 towards the top as face 9 slips on face 29. By constraining the assembly in this way, any gap in the dove tail locking system is eliminated and efficient clamping is insured.

Under these conditions, one can see that surfaces 36 and 7A are in contact, insuring adequate resting face for insert 41 on support 6 and allowing the protection tile to support axial load exerted by the product on the friction surface 27.

The width of finger 46 is slightly less than the width of the opening 23. Existing gaps between surfaces 43 and 26 and surfaces 42 and 25 are limited but sufficient to allow for assembly described above. Friction of the product to be transported, on surface 27 generates ortho-radial forces on insert 41. Contact between surfaces 43 and 26 or between surfaces 42 and 25, depending on scroll rotation direction, allows insert 41 to support these forces.

Finally, the dove tail locking system and especially the contact between male corner 40 of the insert 41 and female corner 10 of the support 6, allows the insert 41 to support centrifugation forces.

During operation, the product to be transported could possibly pass through spaces between support 6 and insert 41 without causing harm to tile resistance. If this intrusion of product can not be tolerated, an appropriate resin can be used to fill the gaps.

In another embodiment than the one shown in FIGS. 3-8, the support 6 is fixed on the flight 3 by means of glue, screws or rivets instead of weld.

In another embodiment than the one shown in FIGS. 3-8, the flight surface used to complete the dove tail locking system may be the outer surface 53 or the rear surface 54.

In another embodiment than the one shown in FIGS. 3-8, the opening 23 of support 6 and the finger 46 of insert 41 may be duplicated and differently positioned, for instance on both side of the parts instead of in their centers. The support may have two symmetrical openings equally spaced from its median plan which the insert comprising similar symmetrical fingers may lodge into. The openings and fingers form complementary nature suffices to ensure assembling and clamping of the system according to the above described principle.

The invention is not limited to the embodiments in the drawings but as explained above in the range of the following claims.

1-9. (canceled)

10. A wear-resistant tile for attachment to a scroll flight of a rotor, comprising:
a support part attachable to the scroll flight and defining an opening; and
an insert having one portion fit within and retained only mechanically to the support part through the opening of the support part, and another portion defining a primary wear-resistant surface.

11. The wear-resistant tile according to claim 10, wherein said one portion is a relatively narrow, integral extension from said other portion.

12. The wear-resistant tile according to claim 10 wherein
the other portion is a plate with a front face defining said primary wear-resistant surface, said face having opposed top and bottom spanning a height, and opposed sides spanning a width; and
said one portion projects downwardly from the plate with a width less than the width of the front face.

13. The wear-resistant tile according to claim 10, wherein
the support part has a profiled front surface defining the opening, including an undercut, and a profiled back surface; and
the one portion of the insert has a back surface that fits within the opening and includes a projecting surface that fits within the undercut of the support part.

14. The wear-resistant tile according to claim 10, wherein
the support part has upper and lower regions with respective front and back surfaces;
the back surface of the upper region is offset from the back surface of the lower region;
the offset is defined by a shoulder; and
the shoulder is aligned within the opening of the support part.

15. The wear-resistant tile according to claim 14, wherein
the upper region of the support part has a profiled front surface defining an upper portion of the opening, including an undercut, and a profiled back surface;
the lower region defines a lower, ledge portion of the opening;
the one portion of the insert has a back upper surface that fits within the upper portion of the opening and includes a projecting surface that fits within the undercut of the support par, and a lower portion including a bottom surface that mates with the ledge of the lower portion of the opening;
whereby when said bottom surface is mated with said ledge, said undercut mechanically retains the projecting surface within the support part.

16. The wear-resistant tile according to claim 15, wherein
the ledge inclines upwardly from the back surface to the front surface of the lower region; and
the bottom surface inclines downwardly from the front to the back surfaces of said one portion the insert;
whereby when said bottom surface is mated with said ledge, said undercut and said ledge mechanically retain the insert at both the upper and lower portions of the opening.

17. The wear-resistant tile according to claim 10, wherein the support has at least one groove-like surface and the insert has a complementary shape that can be fit in the groove-like surface.

18. The wear-resistant tile according to claim 11, wherein the support has a plurality of openings and the insert has the same plurality of extensions.

19. The wear-resistant tile of claim 10, wherein a plurality of tiles are provided at the circumferential edge of said scroll flight, with each respective support part fixed to the flight and each insert mechanically locked to a support part.

20. A conveying device having a rotating scroll flight with circumferentially attached wear-resistant tiles, wherein each tile comprises a support part fixed to the scroll flight and defining an opening; and an insert having one portion fit within and locked only mechanically to the support part through the opening of the support part, and another portion defining a primary wear-resistant surface.

21. The conveying device according to claim 20, wherein the support is welded to the flight.

22. The conveying device according to claim 20, wherein
the support part has a profiled front surface defining the opening, including an undercut, and a profiled back surface;
the one portion of the insert has a back surface that fits within the opening and includes a projecting surface that fits within the undercut of the support part.

23. The conveying device according to claim 20, wherein
the support part has upper and lower regions attached to the flight, with respective front and back surfaces;
the back surface of the upper region is offset from the back surface of the lower region;
the offset is defined by a shoulder; and
the shoulder is aligned within the opening of the support part.

24. The conveying device according to claim 23, wherein
the upper region of the support part has a profiled front surface defining an upper portion of the opening, including an undercut, and a profiled back surface;
the lower region defines a lower, ledge portion of the opening;
the one portion of the insert has a back upper surface that fits within the upper portion of the opening and includes a projecting surface that fits within the undercut of the support part, and a lower portion including a bottom surface that mates with the ledge of the lower portion of the opening; and
said shoulder is attached to the circumferential edge of the flight and the bottom of the one portion of the insert is flush with the front of the flight such that said bottom surface is mated with said ledge and said undercut mechanically retains the projecting surface within the support part.

25. The conveying device according to claim 24, wherein
the ledge inclines upwardly from the back surface to the front surface of the lower region; and
the bottom surface inclines downwardly from the front to the back surfaces of said one portion the insert;
whereby when said bottom surface is mated with said ledge, said undercut and said ledge mechanically retain the insert at both the upper and lower portions of the opening.

26. The conveying device according to claim 20, wherein the support has at least one groove-like surface and the insert has a complementary that can be fit in the groove-like surface to retain the insert within the support part.

27. The conveying device according to claim 20, wherein the support has a plurality of openings and the insert has the same plurality of extensions.

28. The conveying device according to claim 20, wherein said one portion of the insert is locked mechanically to the support part through a dovetail connection with the support part and a mechanical retention of the other portion against the flight by the support part.
